(19) United States
(12) Patent Application Publication
(10) Pub. No.: US 2024/0124318 A1
(43) Pub. Date: Apr. 18, 2024

(54) PROCESS FOR PRODUCING AN AMMONIUM SULFITE AND BISULFITE SOLUTION FROM AMMONIA GAS

(71) Applicant: ThioSolv, LLC, Largo, FL (US)

(72) Inventors: Michael J. Ray, Clearwater, FL (US); Michael F. Ray, Clearwater, FL (US); Matthew F. Ray, Clearwater, FL (US)

(21) Appl. No.: 18/469,136

(22) Filed: Sep. 18, 2023

Related U.S. Application Data
(60) Provisional application No. 63/417,015, filed on Oct. 18, 2022.

(51) Int. Cl. C01C 1/22; C01C 1/28

(52) U.S. Cl. CPC C01C 1/22; C01C 1/28

(57) ABSTRACT

A process for producing ammonium sulfite and ammonium bisulfite from an ammonia gas stream. The process involves injected sulfur dioxide into a circulating liquid stream to an optimal pH that captures gaseous ammonia from a gas stream. The captured ammonia reacts with sulfur dioxide and water to form the desired products.

### CROSS REFERENCE TO RELATED PATENTS

This application claims priority from U.S. Provisional Patent Application No. 63/417,015 filed on Oct. 18, 2022, the entire disclosure of which is part of the disclosure of the present application and is hereby incorporated by reference in its entirety.

### TECHNICAL FIELD

The present invention relates to a process for producing an ammonium sulfite or bisulfite solution from ammonia gas.

### BACKGROUND

The growth in popularity of organic foods and renewable fuels has greatly increased the demand for organic chemical sources. Production of organic chemicals, intermediates, and fertilizers requires the identification of new organic sources and methods for harvesting commercially relevant organic chemicals. Anaerobic digestate, liquids from capped landfills, and other similar sources have been identified as potential ammonia sources for producing high nitrogen fertilizers. Alternately, methods of recovering ammonia from liquids that usually include hydrogen sulfide, thereby creating a sour ammonia stream, are also being explored.

The growing demand for renewable fuels has simultaneously increased the number of anaerobic digesters utilized at concentrated animal feed operations and municipal or industrial sewage treatment plants. These anaerobic digesters, and other low oxygen systems, produce biogas from animal waste, sewage, food, or other organic waste. Anaerobic digesters, and other systems utilizing low oxygen concentrations for conversion of the above-referenced feeds, produce ammonia in the liquids and hydrogen sulfide in both the biogas and liquid digestate. Ammonia produced in the liquid digestate and can be stripped using air, steam, heat, and other methods to generate a low-grade ammonia source.

While stripping with air is a common and effective method, it is necessary to remove the ammonia from the air before it is released to the atmosphere or recycled for continued stripping. Ammonia is a known irritant and is only permissible in the air at concentrations below 25 ppm. The typical concentration of ammonia in stripping air is 1500-4000 ppm, well above the lethal concentration of 500 ppm.

In addition to ammonia, the gas stream may also include hydrogen sulfide. The hydrogen sulfide can leave the stripping air when it is passed through a liquid solution and become entrained in the solution. If the solution is sold as a fertilizer, the hydrogen sulfide may be released when applied to the ground or exposed to air. Hydrogen sulfide is a highly toxic and corrosive gas that can be lethal to humans even at relatively low concentrations.

Conventionally, ammonia entrained in gas streams can be reacted with sulfuric acid to produce an ammonium sulfate solution. While this reaction results in reacting a significant amount of the ammonia, it may fail to react with ammonium hydrogen sulfide if the pH of the ammonium solution is low, or if this solution contacts a low pH source material. If the solution is used as a fertilizer, the hydrogen sulfide may be uncontrollably released. This release may happen when the ammonium sulfate is applied to the soil, when it is blended with other components before application to the soil, when it contacts low pH materials in the soil, or when it is mixed with more acidic ammonium sulfate solutions. The uncontrolled release of hydrogen sulfide may cause serious harm to farmers, agricultural workers, or other individuals in the vicinity. Other processes catalytically convert the ammonia to nitrogen gas using a sulfide catalyst by thermal destruction or other means of destroying ammonia. These processes invariable destroy of the ammonia rather than capturing it.

The primary objective of U.S. Pat. Nos. 7,390,470 and 7,575,732 was to separate ammonia from hydrogen sulfide using pH. These two patents provided for the addition of sulfur dioxide into the liquid stream to change the pH and to provide a means to capture the ammonia from the gaseous stream while maintaining the pH at a low enough level to react as little hydrogen sulfide as possible in that stage of the process. The other objective of these patents was to have a reduced quantity of ABS or diammonium sulfite (DAS) in the circulating solution to minimize the hydrogen sulfide reaction in the contact zone while removing the ammonia from the gaseous stream. A second embodiment disclosed contacting sulfur dioxide, with a third gas ammonia, and a feed liquid containing high levels of ammonium thiosulfate and low levels of ammonium bisulfite/sulfite, comprising at least a portion of the first the ABS leaving the first columns and entering the ATS column. The purpose was to convert a portion of the ammonium sulfite to ammonium bisulfite to allow it to capture additional ammonia in the ammonia scrubbing section where there is no air in the gas stream, only ammonia, hydrogen sulfide, water vapor and a very small amount of hydrocarbons. The ammonia recovery section selectively separated the ammonia from the hydrogen sulfide and minimized the reaction to ammonium thiosulfate. The stream was further used to react with the ammonia and hydrogen sulfide upstream of the ammonia scrubbing section to make ammonium thiosulfate.

In U.S. Pat. No. 7,575,732, in the ATS Column, the ammonium bisulfite/sulfite stream contained higher ratios of sulfite than the stream entering the top of the ammonia absorber. The ammonium bisulfite/sulfite entered the ATS Column, reacted with the ammonia and H₂S in the gas, and the solution was recycled within the column to drive the reaction so that only a small amount of the ammonium bisulfite/sulfite was left in solution, creating a product of primarily ATS. The leaner gas from the ATS column entered the ammonia scrubber, where the same reactions listed above occur but to far less extent. The ammonia absorber solution after passing through the contact zone picking up the ammonia raising the pH stream was then circulated back to the contact zone to pick up SO₂ driving the sulfite to bisulfite and lowering the pH back to the desired pH to circulate back to the top of the ammonia absorber. Unlike the ATS Column, the pH change from the top to the bottom of the ammonia absorber was small, reducing the solution's ability to react with ATS. The bisulfite rose with the addition of sulfur dioxide, and the sulfite content rose with the absorption of additional ammonia.

U.S. Pat. No. 4,146,579 concerns the recovery of molten ammonium bisulfate into a stream of aqueous ammonium bisulfate and recycling it into a reactor that converted ammonium sulfate to ammonium bisulfate.

Existing methods for ammonia extraction with sulfur dioxide mainly involve the separation from hydrogen sulfide and minimize the conversion to ammonium thiosulfate. Currently, a limited amount of ammonium bisulfite is produced on a commercial scale and the demand has increased due to its use in the production of ammonium thiosulfate. Ammonium thiosulfate is a high-sulfur, slow-release fertilizer with exceptional agricultural value.

Therefore, there is a need for improved processes that can extract ammonia from a gas stream to produce ammonium bisulfite or sulfite, which is a high value marketable product that is also safe to use.

### SUMMARY

The present invention describes a novel process for producing an ammonium sulfite and bisulfite solution from ammonia gas using sulfur dioxide. The resulting product is safer to use and has increased value due to the conversion of entrained hydrogen sulfide in the ammonium sulfite and bisulfite solution to ammonium thiosulfate.

According to an embodiment, a process for producing ammonium bisulfite and ammonium sulfite, comprises: routing at least one stream of a gas containing ammonia to a vessel; adding sulfur dioxide into a circulating aqueous solution to adjust the pH to be within a predetermined range; and selectively eliminating ammonia from the gas stream by reacting the ammonia with the sulfur dioxide and water to produce ammonium sulfite and ammonium bisulfite. The routed ammonia gas can be obtained from a reaction where the ammonia is burned or catalytically destroyed, or from an air stream used to strip ammonia out of a water stream, or from a from a digestate liquid stream.

In one embodiment, the sulfur dioxide can be routed to a mixer comprising an aqueous solution containing ammonium bisulfite, ammonium sulfite, and ammonium thiosulfate. The sulfur dioxide can be added in an amount that lowers the pH in the aqueous solution to around 4.5 to 8.5, or in another embodiment, in an amount that lowers the pH in the aqueous solution to around 5.5 to 6.5. The aqueous solution containing sulfur dioxide is circulated to the vessel. The aqueous solution containing sulfur dioxide and the ammonia gas is configured to flow in a countercurrent or co-current pattern for a predetermined time. The predetermined time is sufficient to ensure that substantially all the ammonia gas is reacted out of the gas phase into the liquid/aqueous phase.

The vessel contains one or more contact zones. The vessel comprises a top and a bottom surface—a gas stream having a substantially reduced concentration of ammonia can be released from the top of the vessel and a liquid stream comprising ammonium bisulfite and ammonium sulfite can be discharged from the bottom of the vessel. At least a portion of the liquid stream is diverted as a product stream and another portion of the liquid stream is recycled to the vessel. In one or more embodiments, recycled liquid stream is cooled for optimal temperature control.

In another embodiment, at least two streams of ammonia gas and at least two streams of sulfur dioxide are directly routed to the vessel. The two streams of sulfur dioxide can be routed to one or more contact zones above, below, or in line with gaseous ammonia stream.

In an embodiment, the solution rich in ammonium sulfite and ammonium bisulfite further comprises ammonium thiosulfate. This enriched solution serves as the end product, representing a safe and valuable output of the novel process described herein.

### BRIEF DESCRIPTION OF THE DRAWING

The invention will be described in detail below with reference to the attached drawings which describe or relate to an apparatus and methods for the present invention.

FIG. 1 illustrates a schematic diagram of an exemplary system for removing ammonia from a gas stream to produce an ammonium sulfite and ammonium bisulfite solution according to an embodiment.

FIG. 2 illustrates a schematic diagram of an alternate exemplary system for removing ammonia from a gas stream to produce an ammonium sulfite and ammonium bisulfite solution according to another embodiment.

### DETAILED DESCRIPTION OF THE INVENTION

Depending on the context, all references below to the “invention” may in some cases refer to certain specific embodiments only. In other cases, it will be recognized that references to the “invention” will refer to subject matter recited in one or more, but not necessarily all, of the claims.

When describing a range of pHs, concentrations and the like, it is the Applicant's intent to disclose every individual number that such a range could reasonably encompass, for example, every individual number that has at least one more significant figure than in the disclosed end points of the range. As an example, when referring to a pH as between about 4.5 and 8.5, it is intended to disclose that the pH can be 4.5, 8.5 or any value between these values, including any subranges or combinations of subranges encompassed in this broader range. Applicant's intent is that these two methods of describing the range are interchangeable. Moreover, when a range of values is disclosed or claimed, Applicant also intends for the disclosure of a range to reflect, and be interchangeable with, disclosing any and all sub-ranges and combinations of sub-ranges encompassed therein. Accordingly, Applicant reserves the right to proviso out or exclude any individual members of any such group, including any sub-ranges or combinations of sub-ranges within the group, or any selection, feature, or aspect that can be claimed, if for any reason Applicant chooses to claim less than the full measure of the disclosure, for example, to account for a reference that Applicant may be unaware of at the time of the filing of the application. In particular, the ranges set forth herein include their endpoints unless expressly stated otherwise.

The term “about” means that pH and other parameters and characteristics are not and need not be exact, but may be approximate and/or larger or smaller, as desired, reflecting tolerances, conversion factors, rounding off, measurement error and the like, and other factors known to those of skill in the art. An amount, size, formulation, parameter or other quantity or characteristic is “about” or “approximate” whether or not expressly stated to be such. Whether or not modified by the term “about”, the claims include equivalents to the values stated therein.

Furthermore, the particular illustrative embodiments disclosed herein may be altered or modified and all such variations are considered within the scope and spirit of the present invention. While process is described in terms of “comprising,” “containing,” or “including” various devices/components or steps, it is understood that the process also can “consist essentially of” or “consist of” the various components and steps.

Ammonium bisulfite (ABS) has been primarily used as an oxygen scavenger. However, it can also be used in the production of a high-value, high-nitrogen fertilizer, ammonium thiosulfate (ATS). According to an embodiment, the production of ABS may involve using various organic sources of sulfur dioxide and ammonia obtained from an organic source. The ABS or ammonium sulfide liquid stream that is produced according to one or more embodiments of the invention is a highly valued and marketable product. Ammonium bisulfite/sulfite can be produced at a central facility where it can be distributed as needed to capture varies hydrogen sulfide sources for the production of ammonium thiosulfate.

Unlike the disclosure in U.S. Pat. Nos. 7,390,470 and 7,575,732, the proposed invention involves capturing ammonia from a gas stream where the ammonia is typically burned or catalytically destroyed, or from an air stream used to strip ammonia out of a water stream or digestate liquid stream, and use the captured ammonia to produce an ammonium bisulfite/sulfite stream that can be sold or used for further processing of hydrogen at other locations.

Additionally, unlike the disclosure in U.S. Pat. No. 7,575,732, the present invention is not intended to produce ATS but to react any hydrogen sulfide that may be liberated with the ammonia in the gas stream to ATS and eliminate the hydrogen sulfide from the gas stream to safely vent or recycle the remainder of the gas. If there was no hydrogen sulfide in the gas stream, the final product would be purer. However, having hydrogen sulfide in gas streams is quite common, and removing the hydrogen sulfide can produce a higher value product that also meets safety and environmental regulations.

Unlike the disclosure in U.S. Pat. No. 4,146,579, the present invention does not use aqueous ammonia solution to remove sulfur dioxide from a process gas but uses sulfur dioxide to change the pH of the circulating solution to be able to absorb the dilute ammonia from a gas/air stream to make an ammonium sulfite product.

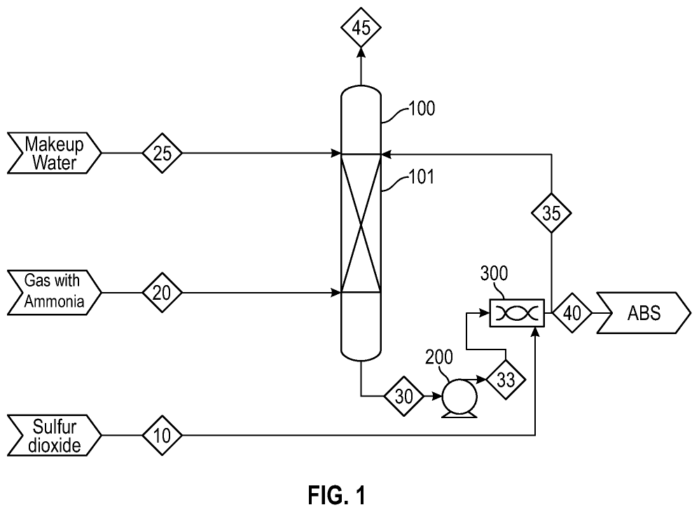

As illustrated in FIG. 1, a first process stream 20 containing ammonia gas is introduced into Recovery Vessel 100. As used herein, the term “Recovery Vessel” encompasses any vessel, container, column or tank known in the art. Advantageously, the ammonia in process stream 20 can be a gas stream containing ammonia captured from a gas stream where the ammonia is typically burned or catalytically destroyed, or from an air stream used to strip ammonia out of a water stream, or from a digestate liquid stream from any source such as, but not limited to, anaerobic digesters, landfills, refineries, wastewater treatment facilities, or any other green ammonia source. In Recovery Vessel 100, the ammonia gas stream enters Contact Zone 101 where it reacts with sulfur dioxide and water/makeup water from stream 25 to produce ammonium sulfite and ammonium bisulfite. As used herein, the term “Contact Zone” may include any combination of towers, columns, trays, vessels, pumps, valves, control systems, and any other equipment known in the art useful in contacting liquids and gases. The number of contact zones can be variable. It will depend on the number of input gas streams, the size constraints of the recovery vessel, and the total amount of ammonia that needs to be removed.

A second process stream containing sulfur dioxide 10 is introduced into Mixer 300 where it is mixed with an aqueous solution comprising ammonium sulfite, ammonium bisulfite, and ammonium thiosulfate. The concentration of the aqueous solution at any one time will depend on process duration, how much product is or has been taken, and how much sulfur dioxide has been added. Mixer 300 can be any static, in-line mixer driven by a motor that is known in the art. According to an embodiment, sulfur dioxide is added in an amount that lowers the pH in the aqueous solution such that it is about 4.5 to 8.5, and preferably about 5.5 to 6.5. It should be easily understandable to persons skilled in the art that the amount of sulfur dioxide added and resulting pH value can be optimized for the capture of ammonia from any input gas stream containing gaseous ammonia (that is, the first process stream). The aqueous solution containing sulfur dioxide can be then circulated via process stream 35 to Recovery Vessel 100 where it enters Contact Zone 101.

The two streams, namely, the aqueous solution containing sulfur dioxide 35 and the ammonia gas 20 in Contact Zone 101 can be configured to flow in a countercurrent or co-current pattern for a predetermined time such that the gas and aqueous streams are contacted for a sufficient time to ensure that substantially all of the ammonia is reacted out of the gas phase into the liquid/aqueous phase. A person skilled in the art can predict the contact time from knowing the input ammonia concentration and ensured by measuring ammonia content in the output gas stream.

Ammonia will react with water, sulfite and bisulfite to form ammonia sulfite and ammonia bisulfite. Ammonia is a base, so the pH of the solution will rise during the reaction. The rise in pH will trap/entrain hydrogen sulfide. Additional sulfur dioxide (with sulfite and bisulfite) will lower the pH of the solution back to the desired range and further react the hydrogen sulfide to ammonium thiosulfate. Hydrogen sulfide will subsequently react with ammonium sulfite and ammonium bisulfite to produce ammonium. The ammonium thiosulfate will advantageously stabilize the remaining sulfite anions and inhibit their oxidation to sulfate and hydrogen sulfide to elemental sulfur and sulfur dioxide at the preferable pH of 4.5 to 8.5.

According to one or more embodiments, ammonia is captured from gas stream 20 using a stream with a ratio of bisulfite to sulfite between 1:2 to 2:1, preferably between 1.3:1 to 1:1.3, converting some of the bisulfite to sulfite (ammonium bisulfite NH₄HSO₃ to diammonium sulfite/ammonium sulfite (NH₄)₂SO₃) by contacting the ammonia with the bisulfite or the sulfur dioxide with the sulfite. The bisulfite to sulfite ratio is controlled by the amount of SO₂ added to the Recovery Vessel 100. The circulation rate of stream 35 is set to keep the amount of bisulfite to sulfite in a range where the pH is between 4.5 and 8.5, preferably between 5.9 and 6.3, to maximize the reaction of the ammonia with the sulfur dioxide to produce the ammonium bisulfite/sulfite solution.

In one embodiment, by keeping the pH in a preferred range of around 5.5 to 6.5 to capture the ammonia and sulfur dioxide, their emissions can be minimized while maximizing the amount of captured ammonia and sulfur dioxide. The process can be operated outside the preferred range but it can become less efficient the farther outside the range the pH moves.

A gas stream 45 having a substantially reduced concentration of ammonia is released from the top of Recovery Vessel 100.

The liquid stream 30 is discharged from the bottom of Recovery Vessel 100 and is circulated via Pump 200 and stream 33 back to Mixer 300. A first portion of liquid stream 40 is extracted as a product solution (also referred to herein as the “product”) comprising primarily ABS and ammonium sulfite (and ammonium thiosulfate, wherein the amount of each will depend on how the solution is circulated before the product is taken) and sent to a storage unit (not shown). A second portion of the liquid stream can be circulated back to the Recovery Vessel 100 as stream 35 containing additional sulfur dioxide from process stream 10. If a low concentration of ammonium sulfite and ammonium bisulfite is desired (for the product), the recycling of the liquid stream 35 can be avoided and the liquid stream can, instead, be sent directly to the storage unit as stream 40. Preferably, the aqueous circulating solution then contains only water and the desired salts from the process.

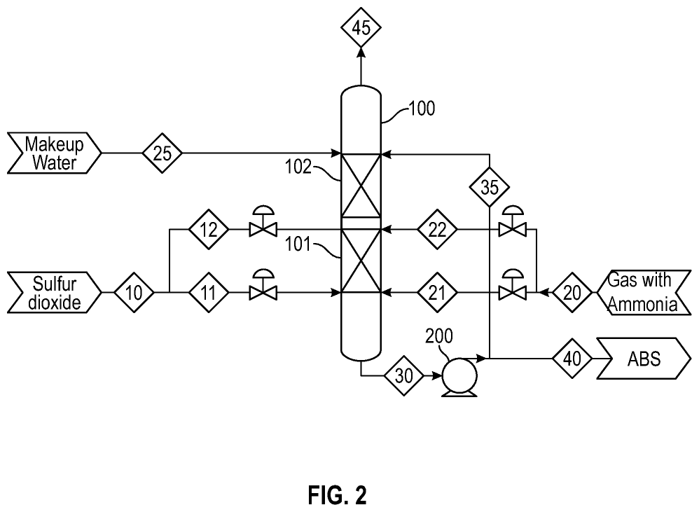

In an alternative embodiment, as shown in FIG. 2, the sulfur dioxide stream 10 is directly routed to Contact Zone 101 in Recovery Vessel 100 as two streams 11 and 12. An ammonia gas stream 20 is also transported to Contact Zone 101 in Recovery Vessel 100 as two streams 21 and 22. The position of the sulfur dioxide streams 11 and 12 can be above, below, or in-line with the ammonia streams 21 and 22. The sulfur dioxide can be distributed in any percentage between streams 11 and 12. For example, the sulfur dioxide can be distributed to different points in the Recovery Vessel 100 using gas regulators, flow controllers, etc. (not shown). All other streams/components are as shown in FIG. 1. The alternative configuration enables the sulfur dioxide to significantly reduce the local pH in the Contact Zone which increases the ability of the liquid solution to capture ammonia. This can be useful for when one location in the Recovery Vessel 100 has increased ammonia and/or a high pH. Additional contact zones, such as Contact Zone 102, can be employed to further facilitate the capture of gaseous ammonia.

In one or more embodiments of the process, a cooler (not shown) for stream 35 is utilized to cool/improve temperature control of the recycled liquid, since the reaction producing the ammonium bisulfite is exothermic. In addition, higher temperatures raise the risk for ammonia or sulfur dioxide emission. A cooler is optional for feed gas streams that are diluted or low in volume as natural convection is sufficient to cool the recycle liquid.

The description presents several preferred embodiments of the present invention in sufficient detail such that those skilled in the art can make and use the invention. As used herein, the words “comprise,” “have,” “include,” and all grammatical variations thereof are each intended to have an open, non-limiting meaning that does not exclude additional elements or steps.

Therefore, the present invention is well adapted to attain the ends and advantages mentioned as well as those that are inherent therein. The one or more embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

1. A process for producing ammonium bisulfite and ammonium sulfite, comprising:
routing at least one stream of ammonia gas to a vessel;
adding sulfur dioxide into a circulating aqueous solution to adjust the pH to be within a predetermined range; and
selectively eliminating ammonia from the gas stream by reacting the ammonia with the sulfur dioxide and water to produce ammonium sulfite and ammonium bisulfite.

2. The process according to claim 1, wherein the vessel contains one or more contact zones.

3. The process according to claim 1, wherein the routed ammonia gas is obtained from a reaction where the ammonia is burned or catalytically destroyed.

4. The process according to claim 1, wherein the routed ammonia gas is obtained from an air stream used to strip ammonia out of a water stream.

5. The process according to claim 1, wherein the routed ammonia gas is obtained from a digestate liquid stream.

6. The process according to claim 1, wherein the sulfur dioxide is routed to a mixer comprising an aqueous solution containing ammonium bisulfite, ammonium sulfite, and ammonium thiosulfate.

7. The process according to claim 1, wherein the sulfur dioxide is added in an amount that lowers the pH in the aqueous solution to around 4.5 to 8.5.

8. The process according to claim 1, wherein the sulfur dioxide is added in an amount that lowers the pH in the aqueous solution to around 5.5 to 6.5.

9. The process according to claim 6, wherein the aqueous solution containing sulfur dioxide is circulated to the vessel.

10. The process according to claim 9, wherein the aqueous solution containing sulfur dioxide and the ammonia gas is configured to flow in a countercurrent or co-current pattern for a predetermined time.

11. The process according to claim 10, wherein the predetermined time is sufficient to ensure that substantially all the ammonia gas is reacted out of the gas phase into the liquid/aqueous phase.

12. The process according to claim 10, wherein the vessel comprises a top and a bottom surface, and wherein a gas stream having a substantially reduced concentration of ammonia is released from the top of the vessel.

13. The process according to claim 12, wherein a liquid stream comprising ammonium bisulfite and ammonium sulfite is discharged from the bottom of the vessel.

14. The process according to claim 13, wherein at least a portion of the liquid stream is diverted as a product stream.

15. The process according to claim 14, wherein another portion of the liquid stream is recycled to the vessel.

16. The process according to claim 15, further comprising cooling the recycled liquid stream.

17. The process according to claim 1, wherein two streams of ammonia gas are routed to the vessel.

18. The process according to claim 17, wherein at least two streams of sulfur dioxide are directly routed to the vessel.

19. The process according to claim 18, wherein the at least two streams of sulfur dioxide are routed above, below, or in line with gaseous ammonia stream.
